(19) United States
(12) Patent Application Publication
(10) Pub. No.: US 2003/0120564 A1
(43) Pub. Date: Jun. 26, 2003

(54) Method and system for retail product management

(76) Inventors: David Jarrett, Granger, IN (US); Mark Blosser, Fishers, IN (US); Duane Wilcoxson, Osceola, IN (US); Brian Masterson, South Bend, IN (US); Scott Dreisbach, Delray Beach, FL (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/310,438

(22) Filed: Dec. 5, 2002

Related U.S. Application Data
(60) Provisional application No. 60/340,590, filed on Dec. 7, 2001.

(51) Int. Cl. G06F 17/60

(52) U.S. Cl. 705/28

(57) ABSTRACT

A method for processing dealership vehicle information is provided, including the step of receiving and storing in one step vehicle data for a dealership. A method is also provided for determining adjusted gross profit on a vehicle based on interest assistance variables.

### TECHNICAL FIELD

The present invention relates to the field of computer software, in particular, retail product management software for automobile dealerships.

### BACKGROUND AND SUMMARY

In general, retail product management systems are computerized systems that assist retailers with tracking, managing, and financing the inventory of products that they sell.

The present invention is an improvement on prior art retail product management systems. It includes a networked system for providing sales reports, inventory reports, and other retail product management-related analysis and consulting services. The application of the illustrated embodiment is directed to automobile dealerships, including both new and/or used vehicle sales. The term “vehicle” as used herein includes any means of conveying persons or things, such as cars, minivans, trucks, sport utility vehicles and other similar vehicles. However, it is understood that the present invention may be applied to other retail product industries.

The present invention provides enhanced analysis and reporting options which may be customized by manufacturer, product, model, or various attributes of a product. The results are communicated to retailers automatically. The improved analysis and reporting capabilities of the present invention are expected to allow retailers to increase gross profit and reduce inventory and interest costs.

Additional advantages of the system of the present invention include: the number of steps required for retailer data to be loaded and converted into a suitable form for storage, searching, and analysis is reduced; a flexible and easy-to-use analysis and reporting structure is provided; and an application platform that can be used in connection with a retailer's Internet portal is also provided.

The present invention includes in a system for managing sales, financial, vehicle and inventory information for a vehicle dealership, a method for processing the dealership vehicle information. The method includes the steps of defining first criteria for receiving dealership vehicle data from a dealership, the first criteria including an indicator indicating whether the dealership vehicle data includes data for at least one of new and used vehicles, defining second criteria for receiving dealership vehicle data from the dealership, the second criteria being dependent on the indicator for new and used vehicles, and receiving and storing in one step vehicle data for each dealership in accordance with the first and second criteria.

The present invention also includes a method for determining an adjusted gross profit for a dealership on a vehicle manufactured by a manufacturer and sold by the dealership. The method includes the steps of determining a free days amount based on a cost of the vehicle and first interest assistance variables associated with the manufacturer of the vehicle, determining an interest cost based on the cost of the vehicle, a number of days in inventory, and second interest assistance variables associated with the manufacturer, and calculating an adjusted gross profit for the vehicle based on a gross profit of the dealership on the sale of the vehicle, the free days amount, and the interest cost.

The present invention further includes a method for managing vehicle sales and inventory for a dealership. The method includes the steps of defining criteria for receiving and storing sales, financial, and inventory data relating to a vehicle in an inventory of a dealership, receiving and storing the vehicle data according to the defined criteria, the vehicle data including data relating to an interest assistance program associated with a manufacturer of the vehicle, calculating for the vehicle, an adjusted gross profit based on the data relating to the interest assistance program associated with the manufacturer of the vehicle, and communicating the adjusted gross profit to the dealership.

The present invention also includes defining the first criteria as an indicator of a source computer system of the dealership and defining the second criteria to include chart-of-accounts parameters.

The present invention further includes the step of formulating a recommendation for the dealership for prioritizing vehicles for sale based on the adjusted gross profit. The present invention also includes the steps of computing an average gross profit for a plurality of vehicles, determining the average gross profit by vehicle model, color, at least one selected vehicle option, vehicle category or vehicle model year.

The present invention also includes the steps of comparing at least one of sales, inventory, and gross profit data by vehicle category, model year, color or how quickly the vehicle was sold. The method also includes data relating to an interest assistance program of the manufacturer, which includes a number of free days and an amount of reimbursement, both provided by the manufacturer.

### BRIEF DESCRIPTION OF THE DRAWINGS

FIG. 1 is a block diagram of one embodiment of the system of the present invention.

FIG. 2 is a process flow diagram of one embodiment of the present invention.

FIG. 3 is a welcome screen for the illustrated embodiment of the present invention.

FIG. 4 is an administration screen for the illustrated embodiment of the present invention.

FIG. 5 is a reports maintenance screen for the illustrated embodiment of the present invention.

FIG. 6 is a reports configuration screen for the illustrated embodiment of the present invention.

FIG. 7 is a store profile screen for the illustrated embodiment of the present invention.

FIG. 8 is a chart of accounts screen for the illustrated embodiment of the present invention.

FIG. 9 is a filters screen for the illustrated embodiment of the present invention.

FIG. 10 is an import configuration screen for the illustrated embodiment of the present invention.

FIG. 11 is an import review screen for the illustrated embodiment of the present invention.

FIG. 12 is a classes review screen for the illustrated embodiment of the present invention.

FIG. 13 is a vehicle types review screen for the illustrated embodiment of the present invention.

FIG. 14 is a color codes review screen for the illustrated embodiment of the present invention.

FIG. 15 is a new accounts review screen for the illustrated embodiment of the present invention.

FIG. 16 is a report listing screen for the illustrated embodiment of the present invention.

FIG. 17 is a report modules screen for the illustrated embodiment of the present invention.

FIG. 18 is an example report generated in the illustrated embodiment of the present invention.

FIG. 19 is a data model for the illustrated embodiment of the present invention.

FIG. 20 is an exemplary field map.

FIG. 21 is a flow diagram for a free days calculation.

### DETAILED DESCRIPTION

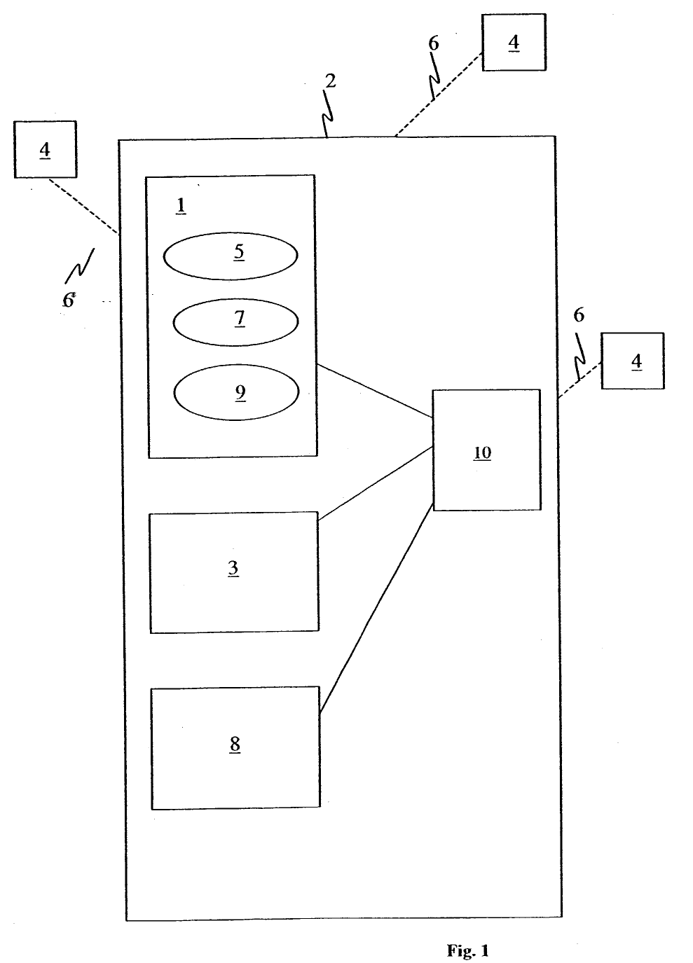

FIG. 1 shows a block diagram of one embodiment of the present invention. In the embodiment of FIG. 1, retailer/dealership data (e.g., financial and inventory data for new and/or used vehicles) is received from one or more remote systems 4 and processed and analyzed at a main computer system 2. Results of the processing and analysis are communicated back to the respective remote systems 4 via communications network 6, for example, in the form of reports that may be used by the retailers to make decisions regarding their inventory.

In alternative embodiments, processing and/or analysis of the data may be performed at one or more of remote sites 4 for a particular retailer/dealership or multiple retailers/dealerships, thus eliminating the need for a main computer system 2. Alternatively, a main computer system 2 could be located at one or more of remote sites 4.

Main computer system 2 includes at least one: memory 1, input device 3, display device 8, and processor 10 coupled together via electrical circuitry, over a network, or other suitable coupling means. Main database 5, user interface software 7, and data processing logic 9 are stored in memory 1. Memory 1 may include a main computer memory or a plurality of distributed memory coupled via electrical circuitry. Database 5 is an organized body of related information, such as a collection of data arranged for search and retrieval, and may include structured tables or records, multiple computer files, or a single file. In the illustrated embodiment, database 5 is designed as a SQL Server relational database that stores the imported data for all retailers or dealerships. One of ordinary skill in the art would readily understand, however, that other database designs may be used equally effectively. In particular, database 5 may be distributed over multiple storage media connected by a network. In the illustrated embodiment, database 5 stores vehicle information collected from a retailer/dealership and converted into a standardized format. Database 5 also stores configurable information about each retailer/dealership.

Each of remote sites 4 also includes a memory 1, input device 3, display device 8, and processor 10. Remote sites 4 may be personal computers, portable or “laptop” computers, handheld devices such as personal digital assistants, or any other suitable computing device.

Input device 3 is, for example, a computer mouse, electronic stylus (or “pen”), touch screen, keyboard, voice recognition system, or other similar apparatus. Display device 8 is a computer monitor, LCD display or similar device (including a display of a personal digital assistant or other handheld or portable device). Processor 10 is one or more microprocessors which executes data processing logic 9 to perform the method of the present invention using data stored in database 5 and data received via one or more input devices 3, and to operate user interface software 7 on display device 8 or on another suitable display device coupled to a dealership system 4 via communications network 6. The illustrated embodiment is implemented as an Internet-based system utilizing third party software products such as Active Server Pages and Crystal Reports, however, it is understood that other suitable products may be used.

In the illustrated embodiment, user interface 7 does not different greatly from retailer to retailer. The underlying processing and analysis functions differ based on the module type (e.g., new or used vehicle module) and the source of the data, i.e., the existing computer system used by each retailer or dealership (e.g., Reynolds, ADP, etc.). For example, in general, the number of files, file mapping procedures, data conversion parameters, and reporting features are determined at least in part by module type and retailer/dealership source computer system.

Main computer system 2 is coupled to one or more retailer or dealership computer systems 4 via communications network 6. Sales, inventory, financial, and other data is received by system 2 from each of the retailers or dealerships 4 via communications network 6. Data and/or reports generated based on the information received from remote sites 4 are transmitted from system 2 to one or more of the retailers/dealerships 4 via communications network 6.

Communications network 6 is any suitable system of components and circuitry capable of enabling computing systems and devices such as systems 2, 4 to communicate, for example, the Internet, an intranet or other suitable internal or external, public, private or restricted network, including networks implemented by telephone lines, DSL links, cable, wireless or other suitable network means.

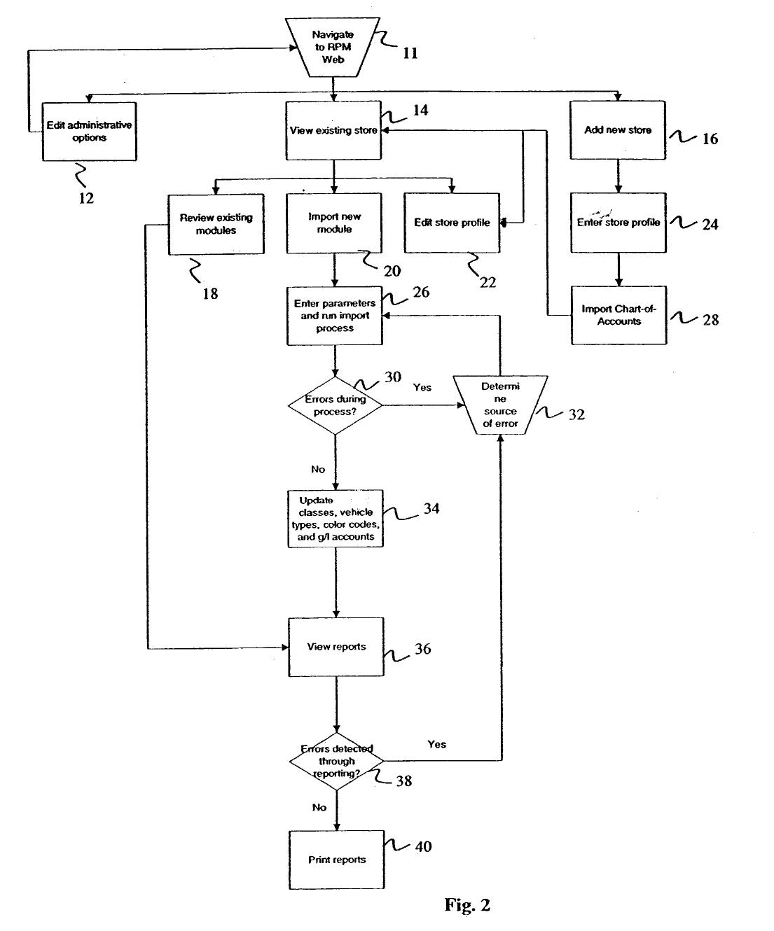

FIG. 2 shows a flow diagram for system 2. Blocks 11, 12, 14, and 16 generally represent activities that may be performed prior to importing data from a remote site 4 or at any time thereafter. Blocks 20, 26, and 34 generally represent activities relating to the import process. Blocks 32, 36, 38 and 40 generally represent activities relating to the analysis of the imported data and generation of reports that may be communicated to remote sites 4.

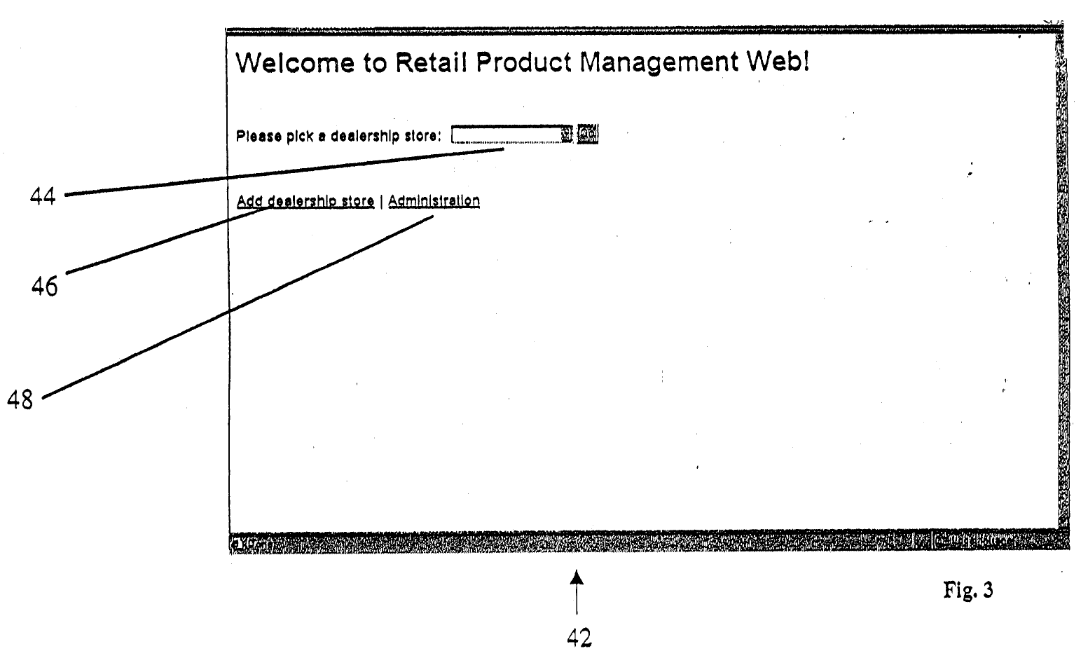

At block 11, a user navigates to a welcome screen or “home page” portion of user interface 7, e.g., screen 42 shown in FIG. 3, using an input device 3. The welcome screen may be a web page on the Internet, or other suitable display screen. A user may be required to establish proper authorization to continue, such as a user name and password, or by other suitable authorization means. As shown in blocks 12, 14, and 16, once a user is logged in, the user may choose to edit administrative options, edit information for an existing retailer or dealership location (or “store”), and/or add a new retailer or dealership location. The user selects an option using input device 3. In the illustrated embodiment, the user uses a computer mouse to point to the desired option and then depresses the mouse key (or “clicks”) to select that option.

At block 12, information that will affect the general operation of system 2 maybe entered or edited. For example, printer setup parameters for printing reports are configured at block 12. It is understood by those skilled in the art that other administrative options, such as setup of user accounts, may be configured at block 12. Access to the administration option may be restricted to users who have established proper authorization.

At block 14, the user may view information relating to an existing retailer or dealership location (or “store”). The user chooses a retailer or dealership location to view, for example, from a pull-down list as shown in FIG. 3, with a mouse or other input device 3. The user may then choose from the following options: import a new module at block 20, review existing modules at block 18, or edit information relating to the retailer location or dealership (the “store profile”) at block 22. As used in the context of this illustrated embodiment, a “module” refers to one or more reports, a group of reports, or a report “package”, that may be generated one time or on a periodic basis, for example, daily, monthly, quarterly, or annually, for one or more retailer or dealership locations, for one or more vehicle types (e.g., new or used vehicles). In the illustrated embodiment, each module also includes the data used in each report and instructions for generating the report.

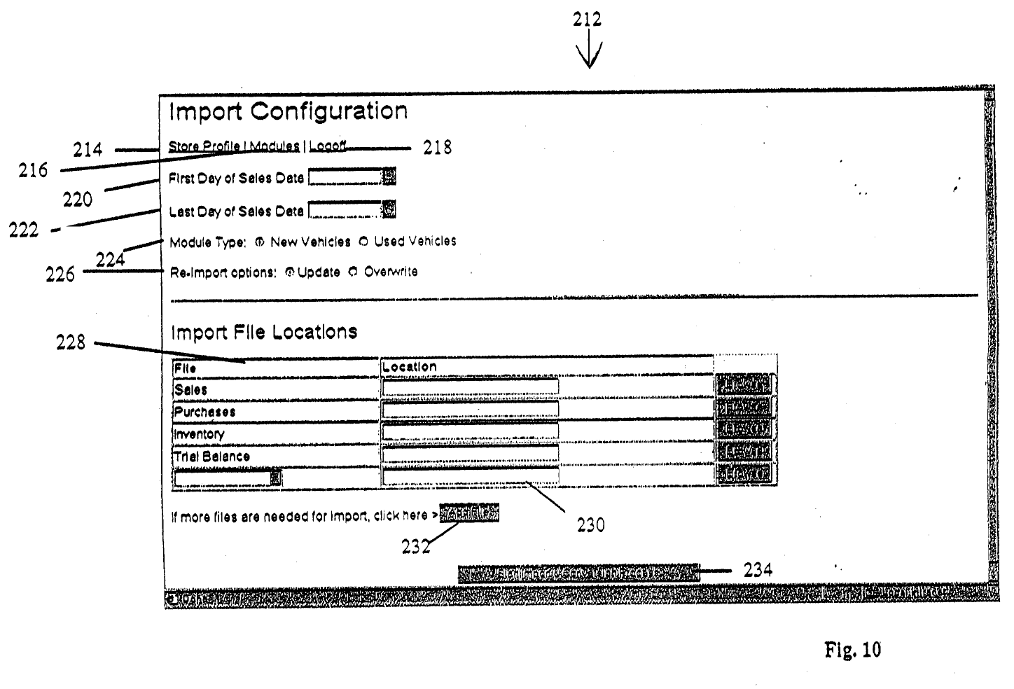

If the user chooses to import data for a new module at block 20, an import configuration page, such as is illustrated in FIG. 10, is displayed. In the illustrated embodiment, during the import process, the “import configuration” page 212 is designed to initiate transfer of the import files from a client retailer or dealership system 4 to main computer system 2 and perform in one step the import processing for the files transferred to main computer system 2. When the import and conversion process is complete, any errors that may have occurred are communicated via user interface 7.

At block 26, the user inputs parameters such as the frequency of import (e.g., monthly) and module type (e.g., new or used vehicles) for the import process. Also at block 26, the user enters the information needed to locate the data to be imported on remote site 4, such as the path and filename of the files. At block 26, the entering of the necessary information and the importing process is performed as a single step.

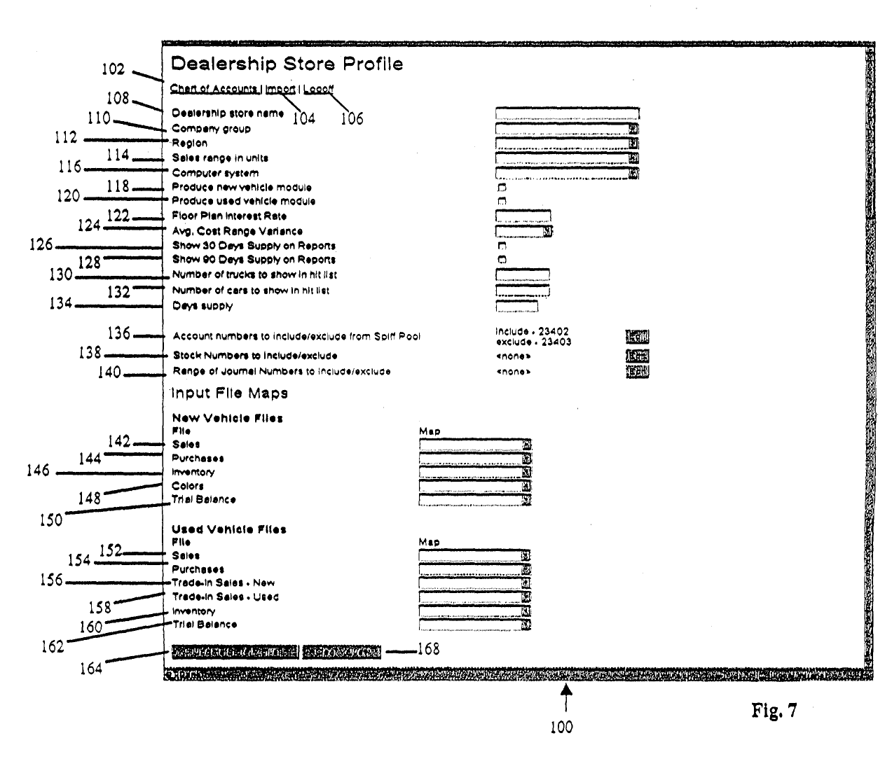

Back at block 16, a user may add a new retailer or dealership location to the system 2. When a user selects this option at block 16, a retailer or dealership location profile page such as is illustrated in FIG. 7 is displayed, permitting a new profile to be created. The profile, which is described in more detail below, is used in the importing and conversion of data and in the compiling of reports. Data for a new profile is input at block 24. Once a new profile is created, a chart-of-accounts for the new retailer or dealership location is imported at block 28. Once the chart-of-accounts is imported, the process proceeds to block 14, or to block 22, where the profile may be viewed or edited.

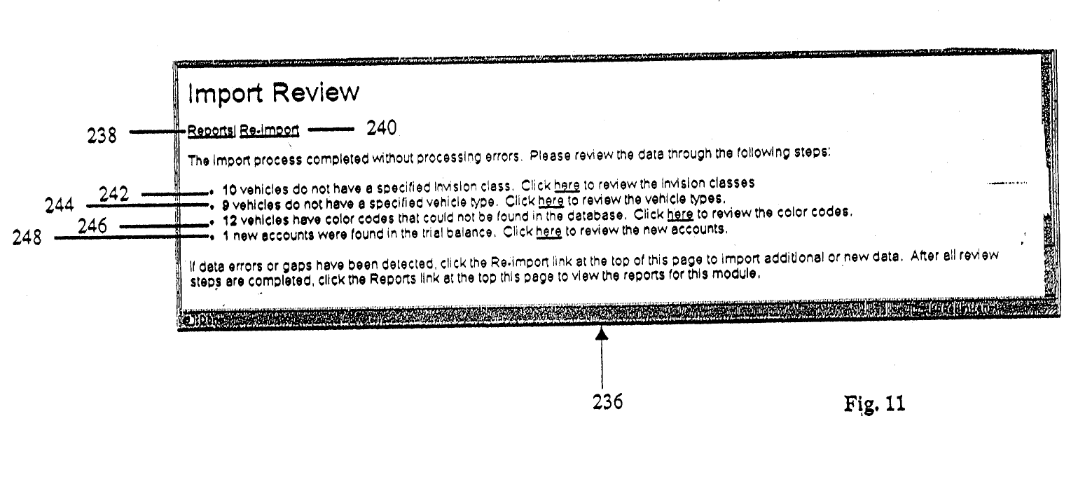

Any errors occurring during import processing are detected at block 30. At block 32, the user may initiate a process to research and resolve an error based on the information obtained at block 30. If an error has been determined, the user may re-import the data at block 26. If the import process executes without generating errors, data updates may be performed, e.g., via an “import review” page 236 such as is shown in FIG. 11, at block 34. Page 236 enables a user to update imported information or enter any missing information, such as classes (e.g., “Invision” classes), vehicle types, or color codes, or to add any new information to the system that was not found in the retailer or dealership's chart-of-accounts.

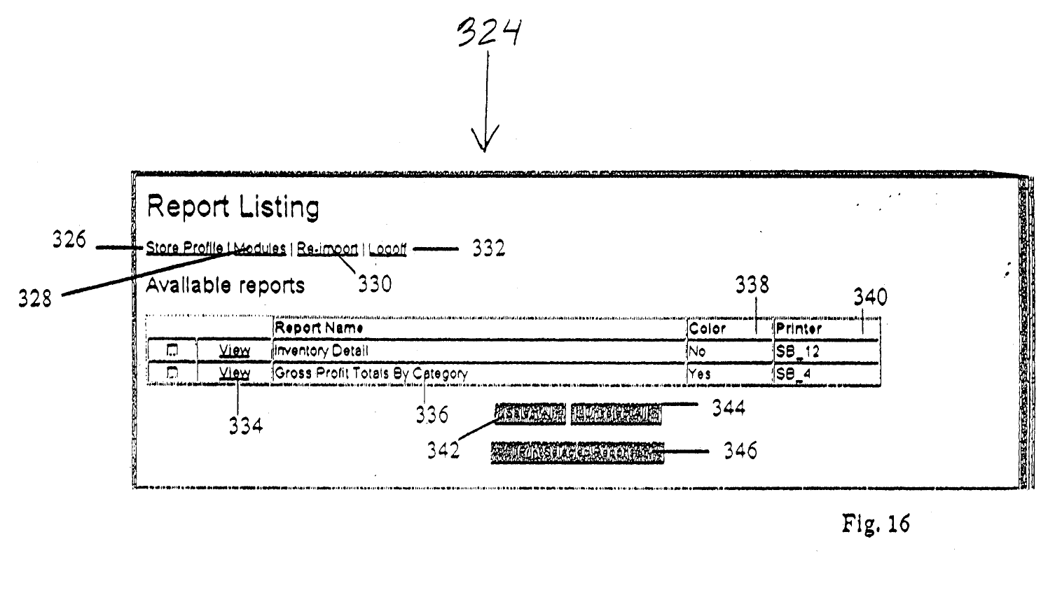

At block 36, the user may view one or more of the reports available for the selected module on a display 324 such as is illustrated in FIG. 16. The user may view the reports on display device 8, e.g., by clicking a “View” link. The user may also print the reports to either a default printer or to another selected printer at block 40. At block 38, if an error is detected through the reporting process, the user may re-import the data by returning to blocks 32, 26.

Once created, modules may be viewed or updated by a user at any time, e.g., by navigating to a “profile” page 100 such as is illustrated in FIG. 7, or an “import configuration” page 212 such as is illustrated in FIG. 10.

FIG. 3 illustrates an example “welcome” screen 42 for the illustrated embodiment of the present invention. A user enters or selects a retailer or dealership location at input area 44. Input area 44 is, for example, a pull-down list of retailer or dealership names from which the user selects the desired location. Input area 44 also may permit the user to type in all or a portion of a retailer or dealership location identifier, such as the retailer or dealership name or an identifying code. This page also allows the user to create a new profile, e.g., by selecting the “add dealership store” link 46, and to perform administration functions, e.g., by selecting the “administration” link 48.

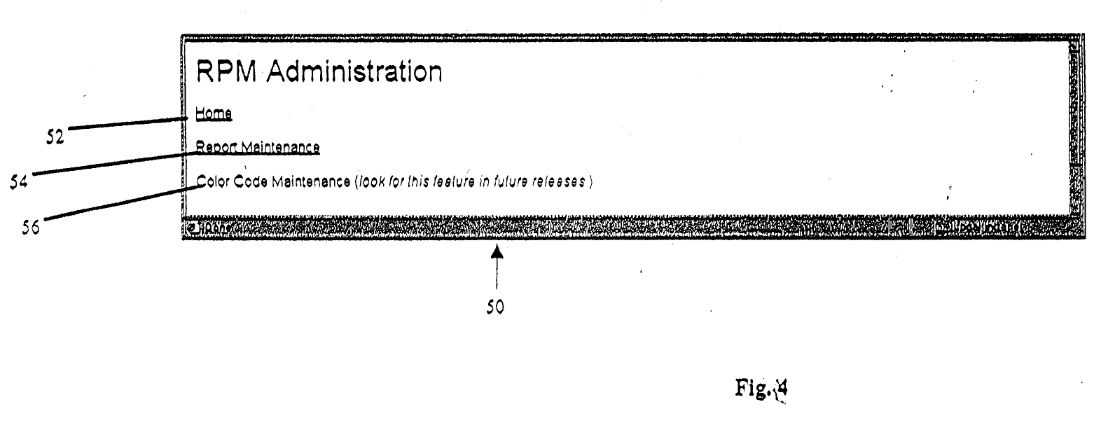

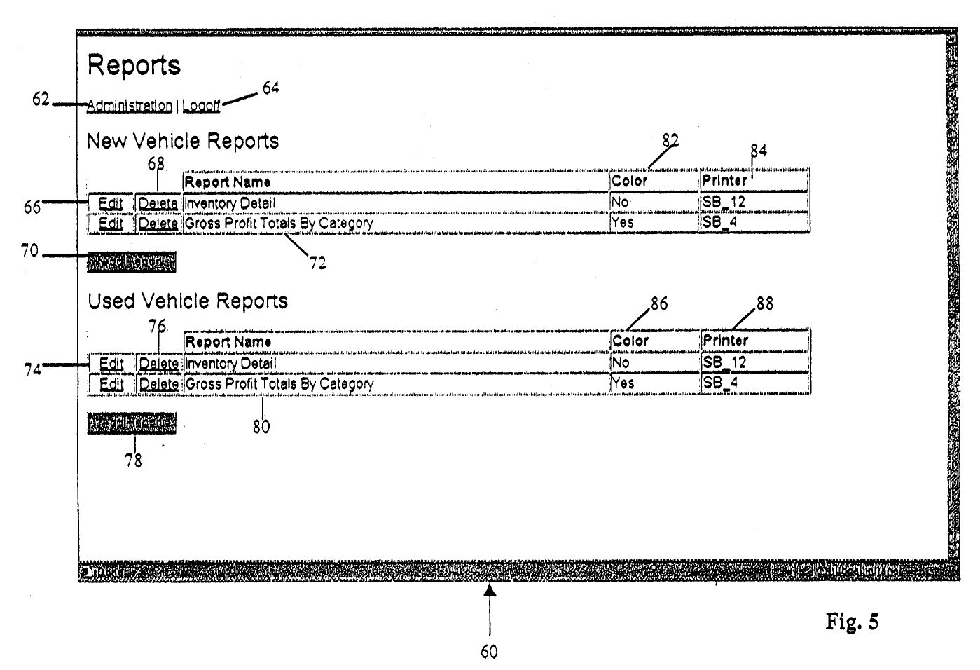

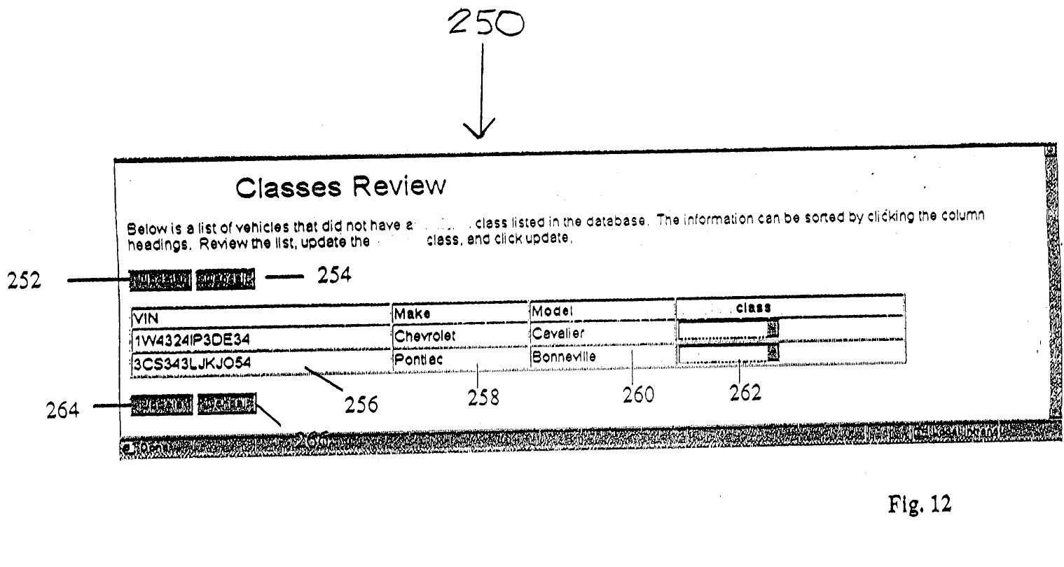

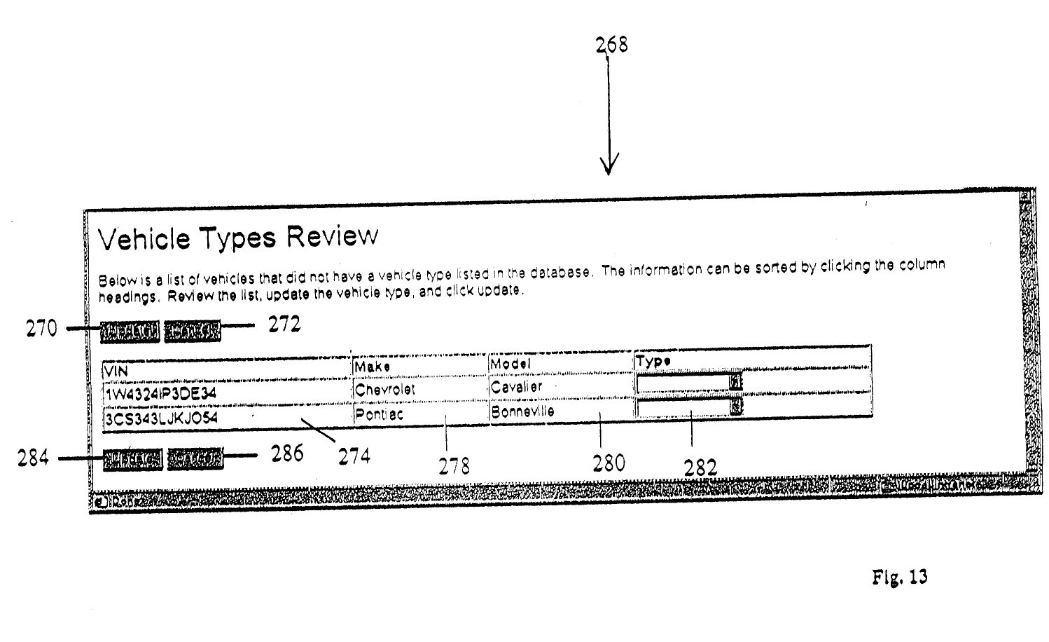

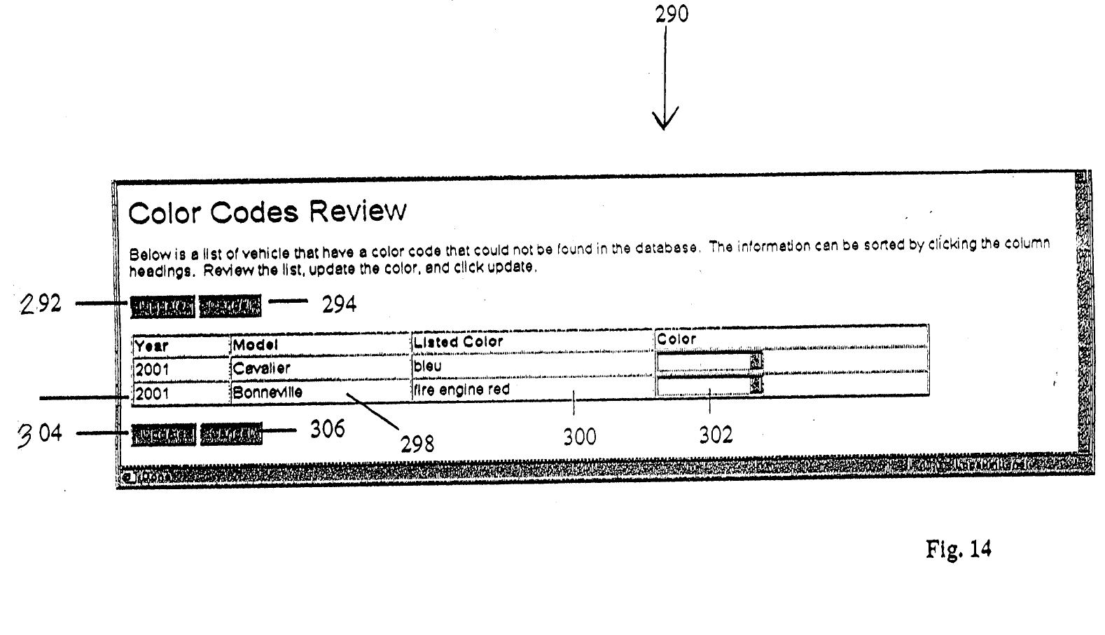

FIG. 4 illustrates an example “administration” page 50 for the illustrated embodiment. Administration page 50 includes links to other pages that assist a user in the overall administration of the system of the present invention, such as a “home” link 52 which, when selected, returns the user to the home or welcome page 42, a “report maintenance” link 54 which, when selected, displays a “reports maintenance” screen 60 such as is illustrated at FIG. 5, and a “color code maintenance” link 56 which, when selected, displays a “color codes review” screen 290 such as is illustrated at FIG. 14. Other links can also be displayed on “administration” page 50, for example, links to screens 250 and 268 illustrated at FIGS. 12 and 13.

FIG. 5 illustrates an example “reports maintenance” screen 60 for the illustrated embodiment. This page allows the user to edit, delete, and add reports to the system of the present invention. Access to these functions may be restricted to only those users with proper authorization. “Administration” link 62 when selected displays an administration screen 50 such as is illustrated at FIG. 4. “Logoff” link 64 when selected disconnects the user from the system of the present invention. The names of available reports 72 are displayed for new vehicles, e.g., under the title “New Vehicle Reports.” The names of available reports 80 are displayed for used vehicles, e.g., under the title “Used Vehicle Reports.” Available reports for new and/or used vehicles include inventory detail, gross profit totals by category, average gross profit per vehicle by model, by color, and/or by options; sales history (including how quickly certain vehicles are sold); interest cost analysis; inventory analysis; and comparison of sales, gross product, inventory, etc., by vehicle model, category, or model year.

“Edit” links 66, 74 when selected permit authorized users to edit the corresponding report 72, 80, listed under, e.g., the “Report Name” heading. “Delete” links 68, 76 when selected permit authorized users to delete the corresponding report 72, 80. Whether the report is printed or displayed in color is indicated at color display columns 82,86. An identification name or code for the printer(s) to which the corresponding reports 72, 80 are printed is indicated at printer display columns 84, 88. The data source for new vehicle reports may be the same as or different from the data source for used vehicle reports. By selecting the “add report” button 78, the user may add a new report to the system as described below.

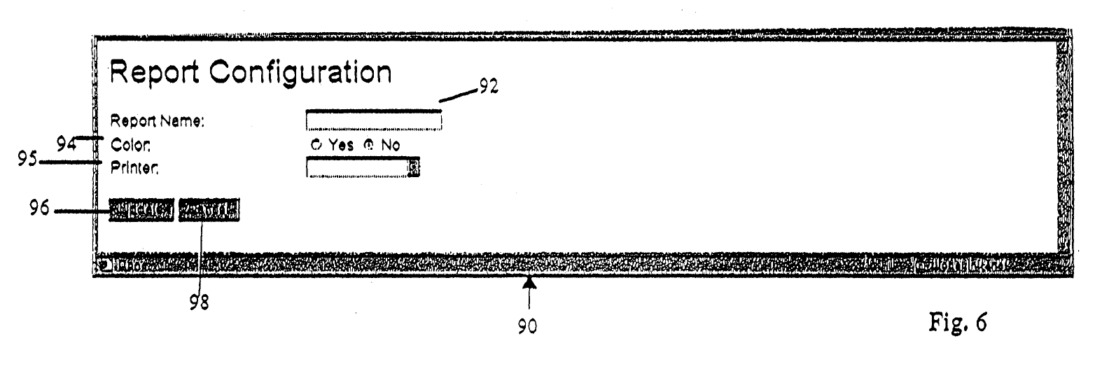

FIG. 6 shows a “report configuration” screen 90 for the illustrated embodiment of the present invention. Page 90 enables the user to edit or add reports to the system of the present invention, and is displayed, for example, when a user selects the “add new report” button 78. The user inputs the name of the report at input area 92. The user selects whether to print or display the report in color at input/selection area 94. In the illustrated embodiment, input/selection area 94 is a radio button which operates to select either the “yes” button or the “no” button. The user inputs or selects from a list the name or identifying code of the printer(s) to which the report will be printed at input/selection area 95. “Update” button 96 when selected updates the report configuration information in database 5. “Cancel” button 98 cancels the user's actions on the report configuration screen 90.

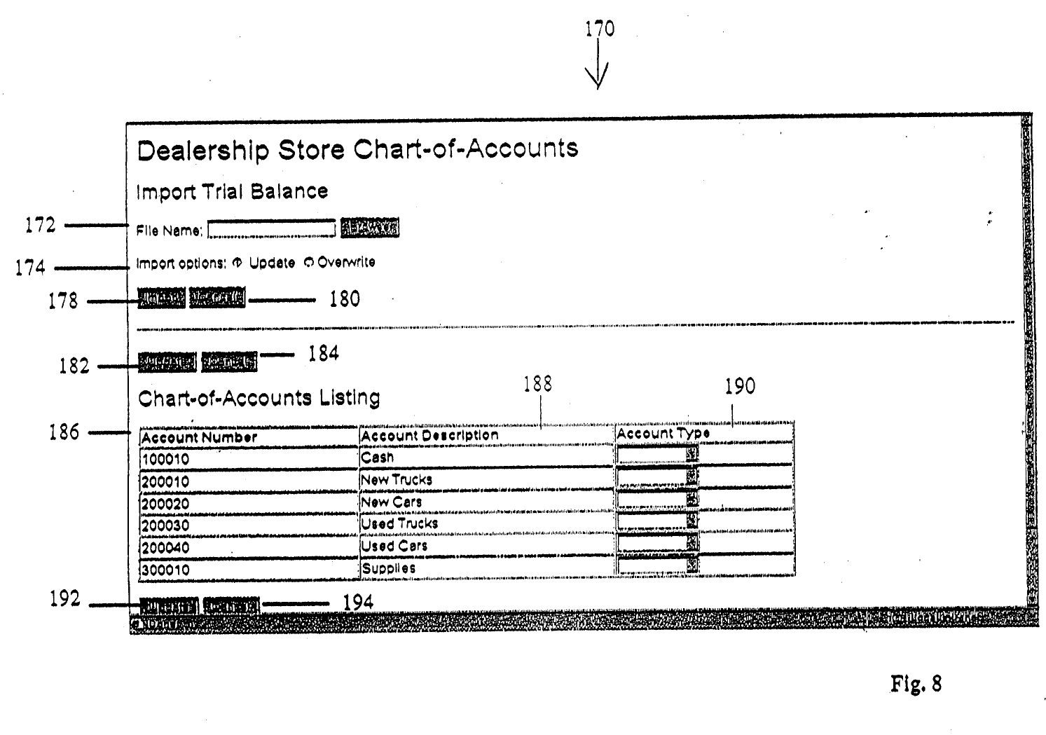

FIG. 7 shows a retailer or dealership “profile” screen 100 for the illustrated embodiment of the present invention. This page enables a user to add or update retailer or dealership profiles. “Chart of accounts” link 102 when selected displays a chart of accounts screen such as is illustrated in FIG. 8. “Import” link 104 when selected displays an import configuration screen such as is illustrated in FIG. 10. “Logoff” link 106 permits the user to cease using the system.

The retailer or dealership name, company group, region, sales range in units, computer system, produce new vehicle module, produce used vehicle module, floor plan interest rate, average cost range variance, show 30 days supply on reports, show 90 days supply on reports, number of trucks to show in hit list, number of cars to show in hit list, days supply, account numbers to include/exclude from spiff pool, stock numbers to include/exclude, and range of journal numbers to include/exclude are titles representative of data entered at input areas 108, 110, 112, 114, 116, 118, 120, 122, 124, 126, 128, 130, 132, 134, 136, 138, and 140, respectively, for a retailer or dealership. These input areas are illustratively a blank entry space where the user manually enters data, a pull down list from which the user selects the data, a check box that the user selects, e.g., to indicate that a new product or vehicle module is to be produced, or other type of input facility.

Some profile data may be requested based on a particular characteristic of a product, such as whether the vehicle type is new or used. For example, in the illustrated embodiment, the data at input areas 122, 124, 126, 128, 130, 132, 142, 144, 146, 148 and 150 are requested if a “produce new vehicle module” flag 118 is activated and fields 152, 154, 156, 158, 160 and 162 are activated if a “produce used vehicle module” flag 120 is activated.

Input file maps for new or used product or vehicle files are also entered via profile screen 100. For example, the input files displayed at input areas 142, 144, 146, 148, and 150 are displayed when the “produce new vehicle module” box 118 is selected. For new products or vehicles, the input files include data relating to, e.g., sales, purchases, inventory, colors, and trial balance. The input files displayed at input areas 152, 154, 156, 158, 160, and 162 are displayed when “produce used vehicle module” box 120 is selected. For used products or vehicles, the input files include data relating to, e.g., sales, purchases, trade-in sales—new, trade-in sales—used, and trial balance. The retailer or dealership profile is updated when the “update store profile” button 164 is selected. The “clear values” button 168, when selected, clears all of the values entered in the input areas on the profile screen 100.

Once a new profile is completed and a user selects the “update profile” button 164, a “chart-of-accounts” page 170, such as is illustrated at FIG. 8, is displayed. Page 170 enables a user to import trial balance data, generate a chart-of-accounts, and update account types for newly imported and existing accounts. The account listing showing account number 186, account description 188, and account type 190 will appear after a trial balance has been imported, or if a trial balance has been imported previously. A user enters a location, e.g., path and filename, for a trial balance file to be imported at input area 172. In the illustrated embodiment, input area 172 is implemented with a browse feature which enables a user to search for the desired file name. At input area 174, a user selects whether imported data should update or overwrite the existing data. The “import” button 178, when selected, results in the trial balance being imported into database 5. The “cancel” button 180, when selected, cancels the current operation. Once trial balance data is imported, a listing of the accounts in the trial balance is automatically generated, including, e.g., the account number 186 and account description 188. A user may review and either approve or edit the accounts list. At input areas 190, a user selects an account type for each account. For example, suitable account types may include inventory, cost of goods sold, and sales. Once a user has edited all of the account types and selects the “update” button 192, the store profile page 100 is reloaded. The system may now be configured to import retailer or dealership data.

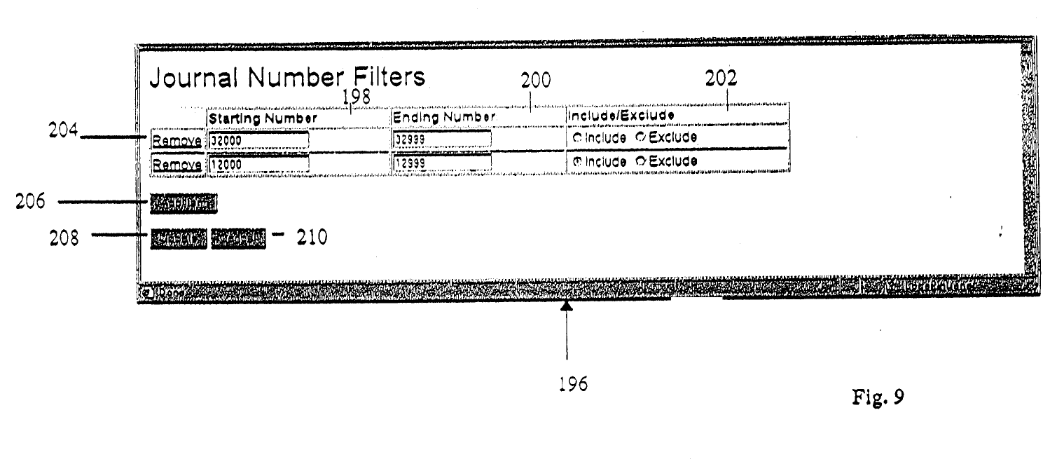

FIG. 9 shows an example “filters” screen 196 for the illustrated embodiment. “Filters” screen 196 is used to update filters applied to imported data. Filters are used to verify that data is imported in a proper format or for reformatting data or organizing data into a particular order. Page 196 allows for both single value and range filters, e.g, using starting number 198, ending number 200, and include/exclude selection area 202. Page 196 also allows the use of wildcards for entering filters. “Remove” link 204 permits a user to remove a filter. “Add item” button 206 permits a user to add a filter. “Update” button 208 permits a user to update the current entry. “Cancel” button 210 permits the user to cancel the current operation.

FIG. 10 shows an example “import configuration” screen 212 for the illustrated embodiment. The “import configuration” page 212 enables the user to import files and build a reporting module for a retailer or dealership. “Store profile” button 214 when selected displays a profile screen such as is illustrated in FIG. 7. “Modules” button 216 when selected permits the user to view report modules. “Logoff” button 218 permits the user to discontinue using the system. The date range, e.g., first and last day of sales data to import, are entered at input areas 220 and 222. The module type (e.g., new or used products or vehicles) is selected at selection area 224. The available module types correspond to the module types listed in the retailer or dealership profile. If the module is not new, but was previously created, a re-import option is selected at selection area 226. In the illustrated embodiment, the available re-import options are “update” and “overwrite.” If “update” is selected, newly imported data will be appended to existing data. If “overwrite” is selected, new data will replace the older data. Under the title “Import File Locations,” the location of the sales, purchases, inventory, trial balance, and other files are entered. If additional files need to be entered, the “add file” button 232 is selected. A browse feature is also available if files need to be added. Once the information in import configuration screen 212 is complete, the “start import and conversion process” button 234 is selected to begin the import process.

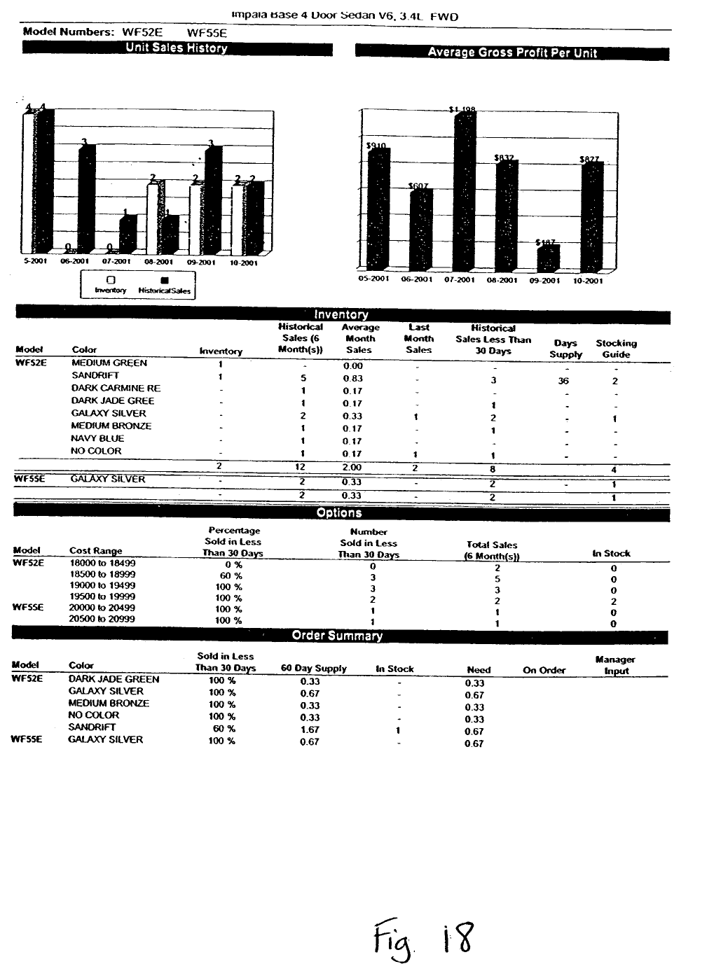

FIG. 11 illustrates an example “import review” page 236. The import review page 236 enables the user to review errors that may have occurred during the import and conversion process initiated by button 234. For example, page 236 permits the user to review products or vehicles with missing classes (e.g. “Invision” classes) at link area 242, vehicles with missing car/truck types at link area 244, vehicles with missing color codes at link area 246, and new general ledger accounts at link area 248. The reports button 238 permits the user to generate or review reports. A sample report is shown in FIG. 18, as discussed below. The “re-import” button 240 if selected permits data to be re-imported.

FIG. 12 illustrates an example “classes review” screen 250. Page 250 enables a user to update classes (e.g., “Invision” classes) of vehicles for which data was imported. Each vehicle that does not have a class already identified in the database 5 is listed by vehicle identification number (VIN) 256, make 258, and model 260. The class for a corresponding vehicle is entered or selected at input area 262. The “update” button 264 when selected updates database 5 with the appropriate class information. The cancel button 266 when selected cancels the current operation.

FIGS. 13 and 14 operate similarly to FIG. 12. The “product or vehicle types review” page 268 enables a user to update information relating to the types of products or vehicles that were imported. For example, for vehicles, the product type may be “small car”, “midsize car”, “sporty car”, “full size car”, “small truck”, “sport utility vehicle”, “full size truck”, “minivan”, or “van.” The “color codes review” page 290 enables a user to update the color codes of the products or vehicles for which data was imported. “Update” buttons 270, 284, 292, 304 and “cancel” buttons 272, 286, 294, 306 operate in the same manner as buttons 252 and 254, respectively. In “product or vehicle types review” page 268, identification number (e.g., VIN) 274, make 278, and model 280 are displayed for products or vehicles that do not already have a type listed in database 5. The product or vehicle type is entered or selected at input area 282 for the corresponding product or vehicle. In “color codes review” page 290, year 296, model 298, and listed color 300 are displayed for products or vehicles that have a color code that was not found in database 5. A new color is entered or selected at input area 302.

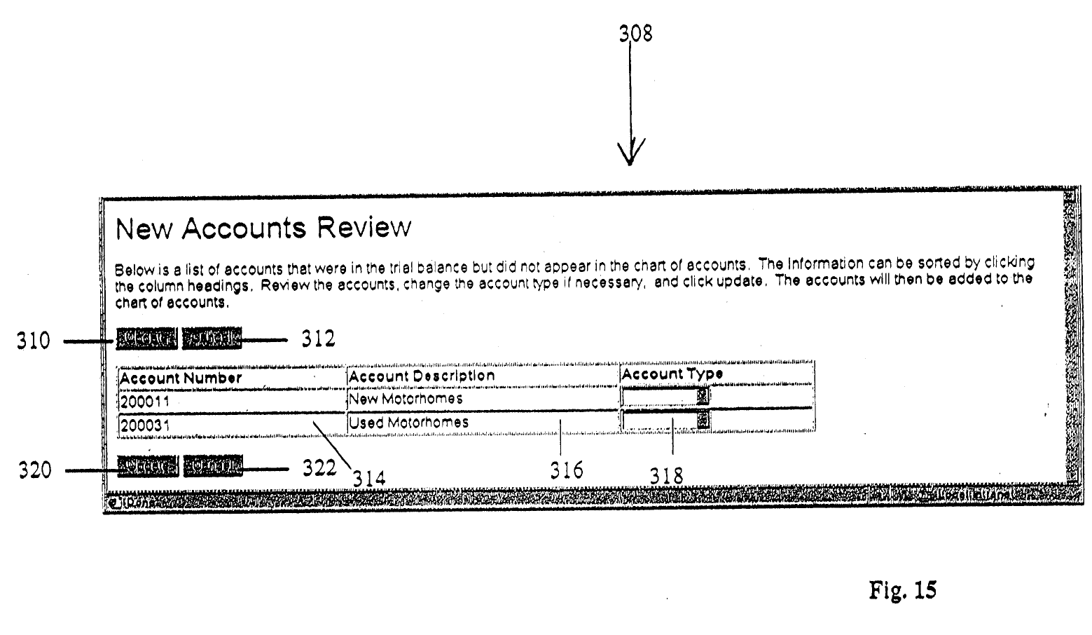

FIG. 15 illustrates an example “new accounts review” page 308. This page enables a user to update accounts that were added to the chart-of-accounts from a trial balance import. “Update” buttons 310, 320 and “cancel” buttons 312, 322 operate in the same manner as previously-described update and cancel buttons, respectively. Account number 314 and account description 316 are displayed for each such account. Account type is entered or selected at input area 318.

FIG. 16 illustrates an example “report listing” screen 324. This page lists all of the reports that can be view or printed for a selected report module. A user can select multiple reports to print at the same time or change the printer to which a report is sent. “Profile” button 326, “modules” button 328, “re-import” button 330, and “logoff” button 332 operate in the same manner as similar buttons previously described. For each report, report name 336, color option 338, and printer option 340 are displayed.

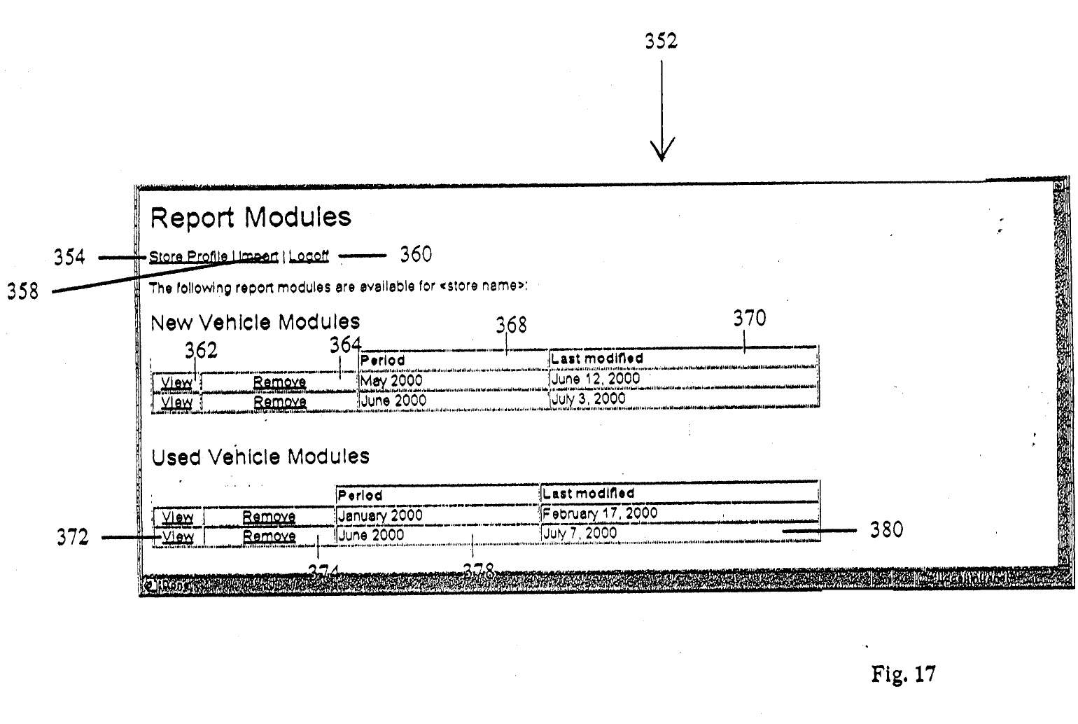

FIG. 17 illustrates an example “report modules” screen 352. This page lists all of the report modules that are available for a selected retailer or dealership. This page enables authorized users to view, edit, and delete modules. “Profile” button 354, “import” button 358, and “logoff” button 360 operate in the same manner as similar buttons previously described. A list of new and used product/vehicle modules for a retailer or dealership is displayed on screen 352. For each module, period by the module 368, 378 and last modified date 370, 380 are displayed. If selected, “view” links 362, 372 permit a user to view the module information. If selected, “remove” links 364, 374 permit a user to remove a module.

FIG. 18 illustrates an example report 382. Sample report 382 displays, for a particular vehicle model sold by a dealer, sales history, gross profit, and inventory information. Below the inventory information, sales data sorted by options is presented, and a summary of orders indicating fast-selling colors is shown below the option data. It is understood that each section of each report may be customized by retailer or dealership, for example, to show data in tabular or graphic format, and that the sections of the report (i.e., the data presented) may also be customized.

Reports are pre-defined or may be created or modified by the user at run-time. Once a report has been generated, the users have the option of creating a hard copy of the report by sending it to a default printer. After the report has been generated to an output screen, the users will have the option of exporting the data, for example, to a spreadsheet (as well as other formats) for further analysis. Any report generated by system 2 may be printed or sent to other individuals via a standard electronic mail or messaging service if such option is selected by a user or if system 2 is programmed to automatically do so.

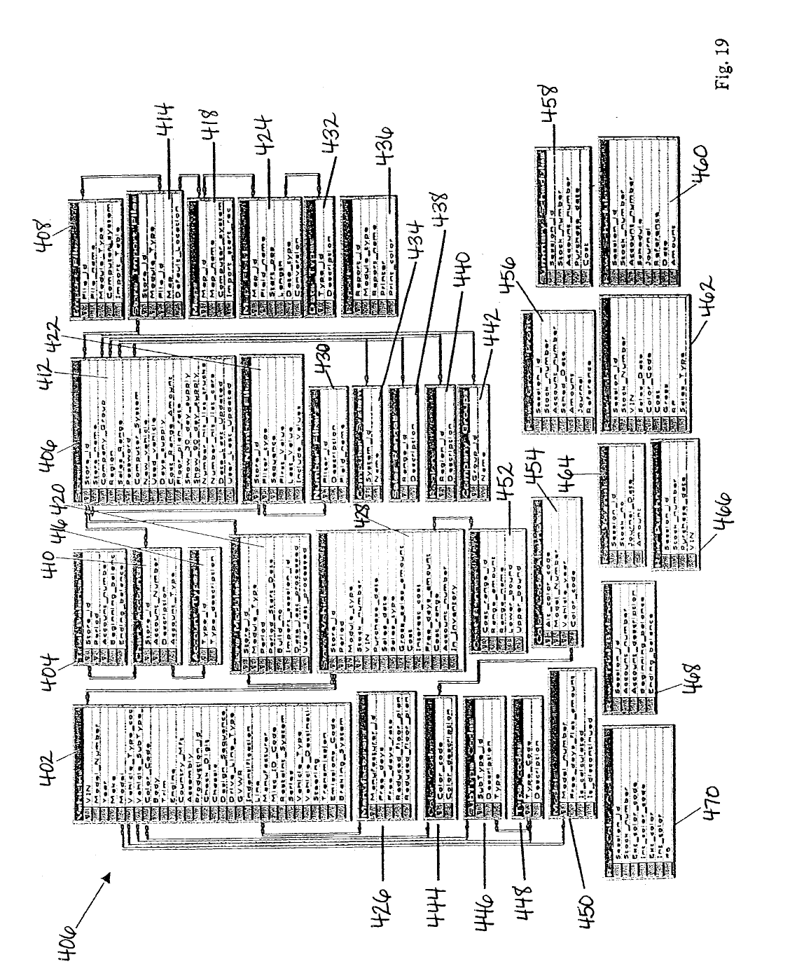

FIG. 19 illustrates a logical data model for database 5 of the illustrated embodiment. In the illustrated embodiment, database 5 includes interlinking tables for products/vehicles 402, trial balance 404, chart of accounts 410, account types 416, locations 406, import files 408, modules 420, location number filters 422, maps 418, map fields 424, manufacturers 426, vehicles 428, number filters 430, data types 432, computer system 434, reports 436, sales ranges 438, regions 440, company groups 442, color codes 444, subtype codes 446, type codes 448, models 450, cost ranges 452, and color code alternates 454. Raw gross profit 456, summary schedules 458, raw schedules 460, raw sales 462, raw journals 464, raw purchases 466, raw trial balance 468, and raw color codes 470 are additional tables in database 5. In the illustrated embodiment, database 5 is a relational database, however, it is understood that any suitable database technology may be used.

The import process of the present invention imports data into database 5 using a field map (described below). Each module pulls the requested data from a source file (e.g., field-by-field, record-by-record) and imports it into corresponding temporary import tables 456,458, 460, 462, 464, 466, 468 and 470. After data is imported, the sales, purchases, and inventory data in the temporary tables is summarized and filtered, based on filters defined in the profile for the retailer or dealership, as discussed above. The data is transferred to a “store vehicles” table 428 in database 5. The trial balance data in the temporary tables is transferred to a trial balance table 404 in database 5. In the illustrated embodiment, data for each vehicle in store vehicles table 428 is processed to calculate carrying costs and cost ranges for the vehicle. All of the vehicles in store vehicles table 428 are processed through the “VINDecoder,” a third-party software tool. The “decoded” VIN information is written to a “vehicles” table 402 in database 5. Data in the temporary “color codes import” table 470 is used to update “color codes” table 444 and “vehicles” table 402. If an import process encounters a field that does not match the corresponding field in database 5 (e.g., type, size, etc.), the import process stops and informs the user that an error or mismatch has occurred and where the error occurred. The import process also checks to see if the imported data is in the proper format according to the field map.

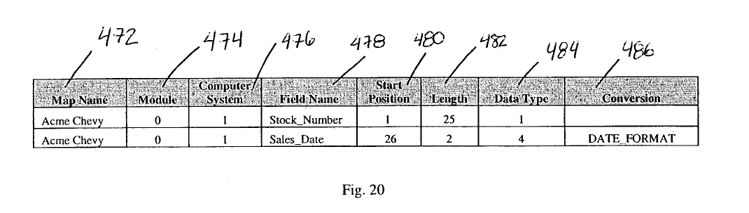

In the illustrated embodiment, each retailer or dealership has a field map stored in database 5. Field maps are entered directly into system 2 or a custom field map may be created outside of system 2 and then transferred into map tables 418, 424 in database 5. Once a field map is stored in database 5, it may be used to map the import file fields for a retailer/dealership to the corresponding fields in database 5. An example field map is shown in FIG. 20.

As shown in FIG. 20, a field map in accordance with the illustrated embodiment includes certain prescribed information for transferring a field of data into database 5, such as a map name 472, module type 474, source computer system 476, field name 478, start position 480, length 482, data type 484 and conversion program 486. Map name 472 is typically the name of the retailer or dealership. Module type 474 is either “new” or “0” for new vehicles, or “used” or “1” for used vehicles. Source computer system 476 is an indicator of the existing system and by the retailer/dealership (e.g., Reynolds, ADP, UCS, etc.). Field name 478 identifies the field name in database 5 that corresponds to the data field being imported. Start position 480, length 482, and data type 484 are used to identify position of the data field in the import file, the length of the field, and the type of data in the field (e.g., character, integer, boolean, etc.). Conversion program 486 identifies a function or computer program used to reformat the data in the field (e.g., to a particular date format).

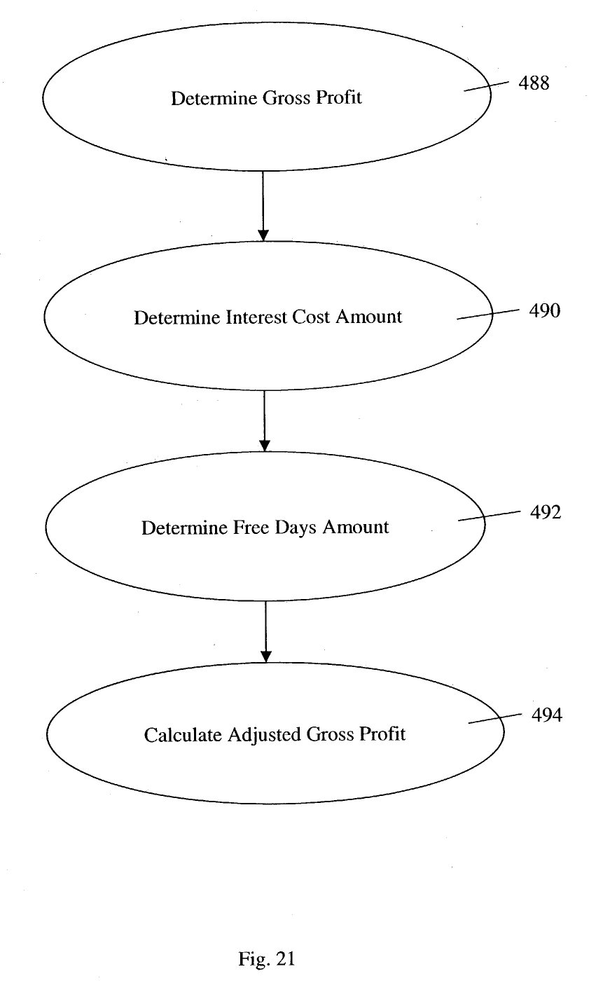

FIG. 21 shows a flow diagram of calculations that are performed using data in database 5. Blocks 488-494 of FIG. 21 show the “free days” calculations. In the retail vehicle industry, vehicle retailers receive a certain number of “free days” from a floor plan lender after a vehicle is delivered to the dealer's lot before interest begins to accrue. If the vehicle is sold before the free days period expires, the dealer gets a credit. The ability to turn inventory quickly can therefore significantly affect the dealer's annual interest costs.

At block 488 of FIG. 20, the gross profit of the retailer for a vehicle is calculated as the gross sales amount minus the dealer's cost. Gross sales amount and cost values are obtained from database 5.

At block 490, the “interest cost” to the dealer is determined. Interest cost is calculated according to the following equation: (Car Cost×Reduced Floor Plan Rate×(Reduced Floor Plan Days/365))+(Car Cost×Floor Plan Rate×(Days in Inventory−Reduced Floor Plan Days/365)). Car cost is the dealer's cost of the vehicle. Reduced floor plan rate is the interest rate used to compute the interest assistance, and may vary by manufacturer. Reduced floor plan days is the number of days for which interest assistance is provided, and may vary by manufacturer. Floor plan rate is the interest rate charged by the dealer's floor plan lender. Days in inventory is the actual number of days a vehicle is in the dealer's inventory. Reduced floor plan days is the lesser of the number of days set by the manufacturer or the actual number of days in the dealer's inventory.

At block 492, the “free days amount” is determined. The free days amount may be set as a flat amount by vehicle model, or calculated separately for each vehicle. If the free days amount is to be calculated, it is calculated according to the equation: Free Days Amount=Cost×Free Days Rate−Interest Cost Amount, where cost is the dealer's cost of the vehicle, free days rate is the interest rate used to compute the free days reimbursement, and interest cost amount is a calculated value as described above. The free days amount is calculated for each vehicle sold during the period (e.g., month) and then averaged for each predefined aging category (e.g., over 30, 60, 90, 120 days, etc.).

At block 494, the dealer's adjusted gross profit, or gross profit adjusted by the free days calculation, is determined. Adjusted gross profit is calculated according to the following formula: Adjusted Gross Profit=Gross Profit+Free Days Amount−Interest Cost Amount. Gross Profit is the amount obtained in step 488 described above. Interest Cost Amount is the amount computed in step 490 described above. Free Days Amount is the amount calculated in step 492 described above.

The present invention performs the free days calculations separately for each vehicle and manufacturer. As a result, the free days analysis is an improvement over prior art systems, which do not customize the calculations by vehicle and manufacturer.

These and other calculations performed by the system of the present invention enable dealerships to identify hot-selling and slow-moving inventory. For example, hot-selling inventory may include vehicle models for which a certain percentage, e.g., at least 50%, turn over in less than 30 days. Slow-moving inventory may include vehicles that turn over in six months. The hot-selling or slow-moving inventory may also be sorted by vehicle color and/or option package. For example, reports generated by the system of the present invention identify whether a certain color or option package has or has not sold well during a specified period, e.g., in the last 30 days, 6 months, etc. Based on these reports, the retailer can specify that no more vehicles be ordered in that color or with that particular option package. On the other hand, if the reports indicate that a certain vehicle model, color, and/or option package is selling well, the dealership can order more of the hot-selling vehicles.

Although the invention has been described in detail with reference to certain illustrated embodiments, it is understood that variations exist within the scope and spirit of the invention, as described and defined in the following claims.

We claim:

1. In a system for managing sales, financial, vehicle and inventory information for a vehicle dealership, a method for processing the dealership vehicle information, the method comprising the steps of:
defining first criteria for receiving dealership vehicle data from a dealership, the first criteria including an indicator indicating whether the dealership vehicle data includes data for at least one of new and used vehicles,
defining second criteria for receiving dealership vehicle data from the dealership, the second criteria being dependent on the indicator for new and used vehicles, and
receiving and storing in one step vehicle data for each dealership in accordance with the first and second criteria.

2. The method of claim 1, wherein the first criteria further include an indicator of a source computer system of the dealership.

3. The method of claim 1, wherein the second criteria further include chart-of-accounts parameters.

4. A method for determining an adjusted gross profit for a dealership on a vehicle manufactured by a manufacturer and sold by the dealership, the method comprising the steps of:
receiving data relating to the adjusted gross profit of a vehicle,
determining a free days amount based on a cost of the vehicle and first interest assistance variables associated with the manufacturer of the vehicle,
determining an interest cost based on the cost of the vehicle, a number of days in inventory, and second interest assistance variables associated with the manufacturer, and
calculating an adjusted gross profit for the vehicle based on a gross profit of the dealership on the sale of the vehicle, the free days amount, and the interest cost, and
communicating the adjusted gross profit to the dealership.

5. The method of claim 4, further comprising the step of formulating a recommendation for the dealership for prioritizing vehicles for sale based on the adjusted gross profit.

6. The method of claim 4, further comprising the step of computing an average gross profit for a plurality of vehicles.

7. The method of claim 6, wherein the average gross profit is determined by vehicle model.

8. The method of claim 6, wherein the average gross profit is determined by vehicle color.

9. The method of claim 6, wherein the average gross profit is determined by at least one selected vehicle option.

10. The method of claim 6, wherein the average gross profit is determined by vehicle category.

11. The method of claim 6, wherein the average gross profit is determined by vehicle model year.

12. The method of claim 4, wherein the first interest assistance variables include a free days interest rate and a number of free days.

13. The method of claim 4, wherein the second interest assistance variables include a reduced floor plan interest rate, a number of reduced floor plan days, and a floor plan interest rate.

14. A method for managing vehicle sales and inventory for a dealership, the method comprising the steps of:
defining criteria for receiving and storing sales, financial, and inventory data relating to a vehicle in an inventory of a dealership,
receiving and storing the vehicle data according to the defined criteria, the vehicle data including data relating to an interest assistance program associated with a manufacturer of the vehicle,
calculating for the vehicle, an adjusted gross profit based on the data relating to the interest assistance program associated with the manufacturer of the vehicle, and
communicating the adjusted gross profit to the dealership.

15. The method of claim 14, further comprising the step of comparing at least one of sales, inventory, and gross profit data by vehicle category.

16. The method of claim 14, further comprising the step of comparing at least one of sales, inventory, and gross profit data by vehicle model year.

17. The method of claim 14, further comprising the step of comparing at least one of sales, inventory, and gross profit data by vehicle color.

18. The method of claim 14, further comprising the step of comparing the adjusted gross profit to data indicating how quickly the vehicle was sold.

19. The method of claim 14, wherein the data relating to an interest assistance program of the manufacturer includes a number of free days provided by the manufacturer.

20. The method of claim 14, wherein the data relating to an interest assistance program of the manufacturer includes an amount of reimbursement provided by the manufacturer.
